(19) United States
(12) Patent Application Publication
(10) Pub. No.: US 2016/0207473 A1
(43) Pub. Date: Jul. 21, 2016

(54) METHOD OF CALIBRATING AN IMAGE DETECTING DEVICE FOR AN AUTOMATED VEHICLE

(71) Applicant: DELPHI TECHNOLOGIES, INC., TROY, MI (US)

(72) Inventor: DIANE NEISIUS, KOELN (DE)

(21) Appl. No.: 14/960,573

(22) Filed: Dec. 7, 2015

(30) Foreign Application Priority Data
Jan. 16, 2015 (EP) 15151429.6

(51) Int. Cl. B60R 11/04; G06T 7/00

(52) U.S. Cl. CPC B60R 11/04; G06T 7/0018; G06T 2207/30256

(57) ABSTRACT

A method of calibrating an image acquiring device which is arranged at a vehicle at an installation height, assumes a provisional value for the installation height and a defined path length in a road plane. The measurement path is projected onto the image plane by means of a perspective projection using the provisional value of the installation height in order to determine measurement positions in the image which correspond to a path start and to a path end of the measurement path. An object located at two measurement positions at two different times is identified in consecutively acquired images. A calculated path length of the measurement path is determined from the time difference between the different times and the speed of the motor vehicle. An actual value for the installation height is determined using a comparison of the defined path length with the calculated path length.

### CROSS-REFERENCE TO RELATED APPLICATION

This application claims the benefit under 35 U.S.C. §119(a) of European Patent Application EP 15151429.6, filed 16 Jan. 2015, the entire disclosure of which is hereby incorporated herein by reference.

### TECHNICAL FIELD OF INVENTION

This disclosure generally relates to a method of calibrating an image acquiring device arranged on a vehicle at an installation height above a road plane and which is able to detect images of an environment of the motor vehicle at time intervals.

### BACKGROUND OF INVENTION

Image acquiring devices such as digital cameras are used in modern motor vehicles including automated vehicles as input sensors for different kinds of driver assistance or automation systems, for example for lane departure warning assistants, lane keeping assistance systems, recognition systems for vehicles and pedestrians and systems for automatic road sign recognition or for automatic headlamp beam height control. It is generally necessary in such applications to determine the position of the objects of interest in world coordinates using the position of recognized image objects in image coordinates. A calibration of the image acquiring device is necessary for this conversion between image coordinates and world coordinates. In particular the position and the orientation of the camera relative to the associated motor vehicle are determined within the framework of such a calibration. An important calibration parameter is the tilt angle or the pitch angle of the camera. This can be determined by means of additional sensors, for example. To avoid the high effort associated with this, the tilt angle can also be estimated using objects recognized in the acquired images, for example by estimating the position of the vanishing point in the image. Such a method is disclosed in EP 2 704 096 A1.

An estimation of the position of the vanishing point in the image generally does not allow any conclusion on the installation height which is, however, likewise required for a calibration process. With driver assistance systems for passenger cars, this is generally not problematic since here the installation height for all vehicles of a series is typically the same and the value for the installation height can thus be predefined as a constant for the calibration.

It is, however, in particular not appropriate to assume a constant installation height of the image acquiring device in driver assistance systems for trucks. Trucks are namely typically manufactured with an individual assembly of modular components such as the basic frame, wheel suspension, driver's cab and transport superstructure in numerous different versions. Different installation heights for the camera thus result depending on the version. There is a further problem in that many trucks are equipped with air suspension systems. Such air suspensions can have a considerable stroke and can change the installation height dynamically. In addition, the installation height also varies with the load of a truck. Camera calibration processes which assume a constant installation height can thus result in a performance reduction and even in a malfunction of the associated driver assistance system.

### SUMMARY OF THE INVENTION

Described herein is a method to make possible with simple means a reliable calibration of image acquiring devices arranged at motor vehicles, the calibration including the installation height of the image acquiring device.

A preselected or provisional value is assumed for the installation height in accordance with the invention. Furthermore, at least one measurement path disposed in the road plane is defined with a defined path length. The measurement path is projected onto the image plane of the image acquiring device by means of a perspective projection using the provisional value for the installation height in order to determine two measurement positions in the image which correspond to a path start and to a path end of the measurement path. At least one object which is located at the two measurement positions at two different times is identified in consecutively acquired images by means of an image processing system. A calculated path length of the measurement path is determined from the time difference between the different times and the current speed of the motor vehicle. An actual value for the installation height is then determined from the provisional value using a comparison of the defined path length with the calculated path length. The image acquiring device is calibrated using the actual value of the installation height.

In accordance with the invention, the determination of the installation height is therefore traced back to a length measurement in the road plane in world coordinates. A length measurement in world coordinates has the advantage that the result is not influenced by the orientation of the camera. The invention is inter alia based on the recognition that on a perspective projection between the road plane and the image plane, the relationship between the world coordinates and the image coordinates is linear with respect to the installation height. The deviation of the provisional value for the installation height from the actual value for the installation height can thus be determined from a comparison of a path defined in the world and projected into the image with that (calculated) path which is actually covered in the world by a reference object recognizable in the image on passing through the projected path. The invention provides starting the calibration process with a start value for the installation height which can be arbitrary in principle and then to correct this value within the framework of the method. To achieve a high robustness of the method, it is preferred to use a “probable” or “expected” value as the provisional value for the installation height. Such a value is meant by this which is within a range of possible actual values for the installation height. It has been found that a particularly precise and numerically stable vertical calibration of vehicle cameras is possible by means of a method in accordance with the invention. Since the method in accordance with the invention works for a relatively wide range of installation heights, it cannot only be used for driver assistance systems of passenger vehicles, but also for driver assistance systems of trucks.

Further developments of the invention are set forth in the dependent claims, in the description and in the enclosed drawing.

The actual value for the installation height is preferably determined by a multiplication of the provisional value for the installation height by the ratio from the defined path length and the calculated path length of the measurement path. This results from the theorem of intersecting lines when observing those eye rays which are associated with the path start and with the path end of the measurement path. It is therefore preferred to carry out the matching of the provisional value of the installation height using the theorem of intersecting lines. The simplicity of the calculation is a particular advantage in this respect.

The projection of the defined measurement path onto the image plane of the image acquiring device can be carried out by means of an “inverse perspective mapping” algorithm. A pinhole camera model can in particular be used for fixing the projection equation. Such processes can be used in an advantageous manner to convert a measurement path defined in world coordinates into image coordinates. An inverse perspective mapping algorithm is described, for example in the paper “Inverse Perspective Mapping Simplifies Optical Flow Computation and Obstacle Detection” by Mallot et al., Biological Cybernetics 64(1991), pages 177-185.

A measurement path is preferably defined which extends at least substantially in parallel with a direction of travel of the motor vehicle. A relatively simple calculation results from this. It is in particular ensured in this manner that the time difference correlates directly and immediately with the path length.

An embodiment of the invention provides that scanning lines are determined as measurement positions which preferably extend horizontally through the entire image and that the identification of at least one object respectively comprises the application of an object recognition criterion on all picture elements associated with a scanning line. Each object which satisfies the object recognition criterion and which passes the scanning lines is thus reliably recognized.

A check can be made for the identification of an object at a measurement position whether a brightness jump occurs at the respective measurement position when observing a plurality of images acquired after one another. This allows a particularly simple object identification. Brightness jumps occur, for example, at the start and at the end of a road marking and in particular repeatedly with interrupted road markings. The detection of such brightness jumps can take place relatively fast and simply. It can be carried out, for example, using a threshold value-based filtering.

An embodiment of the invention provides that the identification of an object is carried out at a measurement position using an output signal of a separate object recognition system, in particular of a classifier, associated with the image acquiring device. The effort for the object recognition within the framework of the calibration process can be reduced by using the external classification results. If already recognized road markings are used as objects for the length measurement, it is ensured that the measurement takes place in the road plane.

A specific embodiment of the invention provides that a front marking edge and/or a rear marking edge of an interrupted lane marking is identified. This is advantageous in that, on the one hand, the brightness jumps present with marking edges can be easily recognized and, on the other hand, interrupted lane markings are present in the image in most traffic situations.

A further embodiment of the invention provides that a temporal brightness signal, that is a brightness signal dependent on the time, is formed for each of the determined measurement positions using a series of consecutively acquired images and is transformed by a coordinate transformation, preferably while integrating the speed of the motor vehicle, into a spatial brightness signal, that is a brightness signal dependent on the position in the world. The integration can in particular be carried out by means of a numerical integration process. To keep the calculation effort small, the trapezoidal rule can be used, for example. Spatial brightness signals can be analyzed directly with respect to object positions, distances, and the like.

In accordance with a further embodiment of the invention, the spatial brightness signals of the two measurement positions are compared with one another by means of autocorrelation to determine the spatial distance between corresponding points of the two spatial brightness signals as a calculated path length of the measurement path. This takes the circumstance into account that the brightness signals generally suffer from noise and are defective. An autocorrelation between two spatial brightness signals allows a suppression of such interference sources and thus a particularly robust determination of the path length.

A further embodiment of the invention provides that a plurality of measurement paths, in particular more than five measurement paths, are defined, wherein respective path lengths are determined for all measurement paths, wherein the corresponding results are in particular filtered before the calibration. Interference is averaged out in this manner so that the stability of the process is particularly high.

The provisional value for the installation height can be predefined using a priori information and in particular in dependence on a type of the motor vehicle. A starting value for the installation height which is sufficiently exact for the ensuring of the stability of the process can generally be given, starting from the known type of the motor vehicle for which the respective driver assistance system is provided.

In accordance with a further embodiment of the invention, the calibration of the image acquiring device is only carried out when the current speed of the motor vehicle exceeds a threshold value and/or when the current yaw rate of the motor vehicle falls below a threshold value and/or an estimated error of the actual value for the installation height falls below a predefined error threshold value. It is precluded in this manner that erroneous calculation results are used for the calibration. If necessary, the driver of the motor vehicle can be informed of the presence of errors so that he can optionally take suitable measures.

The invention also relates to an apparatus for recognizing and tracking an object from a vehicle using an image capturing device which is arranged at the vehicle at a predefined installation height above the road plane and which is configured for taking images of the vehicle environment at time intervals and having an image processing system which is configured for carrying out a method as described above.

The invention furthermore relates to a computer program product which contains program instructions which execute a method as described above when the computer program is run on a computer.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 shows in schematic form two trucks having different driver's cabs in which a respective image detection device is mounted;

FIG. 2 shows the projection of a world plane onto an image plane in a pinhole camera model;

FIG. 3 shows the relationship between the path length of a measurement path and the installation height of an image acquiring device;

FIG. 4 is a flowchart which represents the starting sequence of a calibration method in accordance with the invention;

FIG. 5 is a flowchart which represents the main loop of a calibration method in accordance with the invention;

FIG. 6 shows the projection of measurement paths into the image using a pinhole camera model;

FIG. 7 shows test results of a calibration method in accordance with the invention for the application “passenger vehicle”; and

FIG. 8 shows test results of a calibration method in accordance with the invention for the application “truck”.

### DETAILED DESCRIPTION

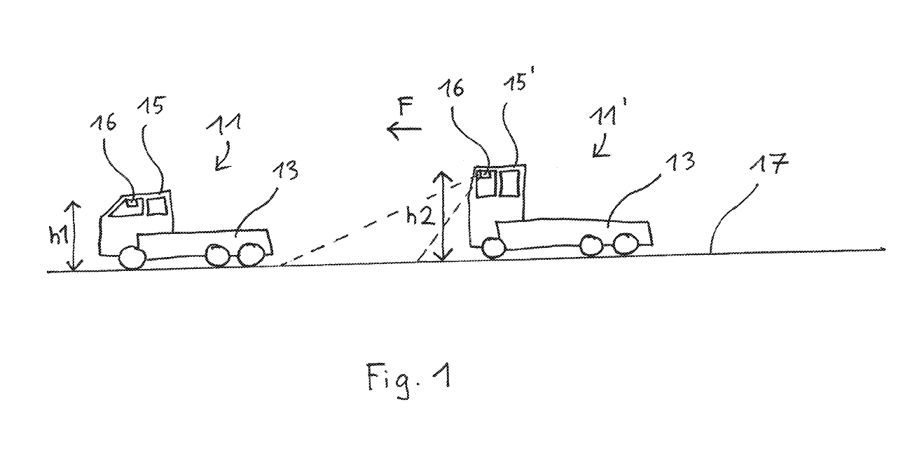

FIG. 1 shows in a schematic form two trucks 11, 11′ which each have a chassis 13 and a driver's cab 15, 15′. While the chassis 13 has the same design for both trucks 11, 11′, the driver's cabs 25, 25′ differ inter alia with respect to their heights. An image acquiring device in the form of a digital camera 16 is attached in each driver's cab 15, 15′ and is able to detect images after one another in time of a traffic space located in front of the respective truck 11, 11′ and in particular of a region of the road plane 17, as is shown by dashed marginal rays with reference to the truck 11′ at the rear in the image. The cameras 16 are each coupled to downstream image processing devices, not shown in FIG. 1, and together with them form respective image processing systems.

Each of the cameras 16, including the associated image processing device, is associated with one or more driver assistance systems, for example with a lane departure warning assistant. Due to the different designs of the two driver's cabs 15, 15′, the cameras 16 of the two trucks 11, 11′ are arranged at different installation heights h1, h2 above the road plane 17. This means that the installation height of a camera 16 is normally not known in advance so that not only the angular orientation of the camera 16, but also its installation height is to be determined in a calibration procedure.

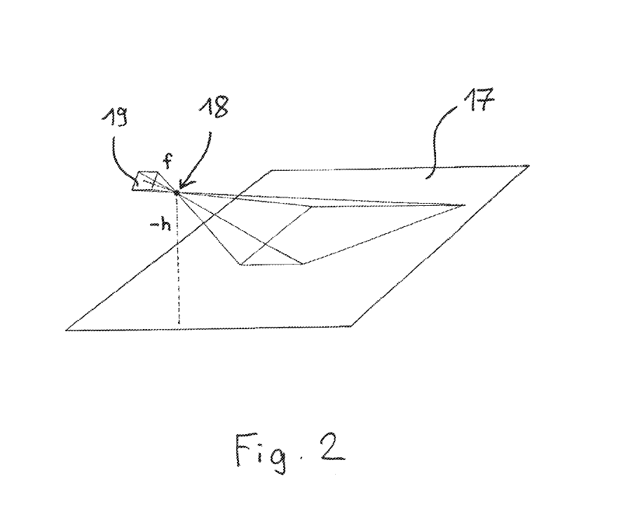

This takes place in accordance with the invention using an inverse perspective mapping algorithm. Such an algorithm is disclosed, for example, in the paper already named above “Inverse Perspective Mapping Simplifies Optical Flow Computation and Obstacle Detection” by Mallot et al., Biological Cybernetics 64(1991), pages 177-185. The algorithm is based on a pinhole camera model as is shown in FIG. 2. The origin 18 of the pinhole camera model typically corresponds to the center of the camera lens and is located at a height h above the road plane 17 which corresponds to the installation height. The image plane 19 is at a spacing f behind the origin 18. On the projection of the road plane 17 onto the image plane 19, all eye rays run through the origin 18. It can be shown that with a perspective projection using a pinhole camera model as shown in FIG. 2, the image coordinates (x_{I}, y_{I}) of a scene point fixed in world coordinates (x_{w}, y_{w}) linearly depend on the installation height h.

(x_{w}, y_{w})=−h(q₃₁x_{I}+q₃₂ y_{I}−q₃₃f)(q₁₁x_{I}+q₁₂y_{I}−q₁₃f,q₁₁x_{I}+q₁₂y_{I}−q₁₃f) Eq. 1

particularly applies qᵢⱼ here designates the matrix elements of the projection matrix. This means that the mentioned linearity applies component-wise. The ratio of the length of a path predefined in the world to the length determined by measurement in the image therefore depends linearly on the installation height h.

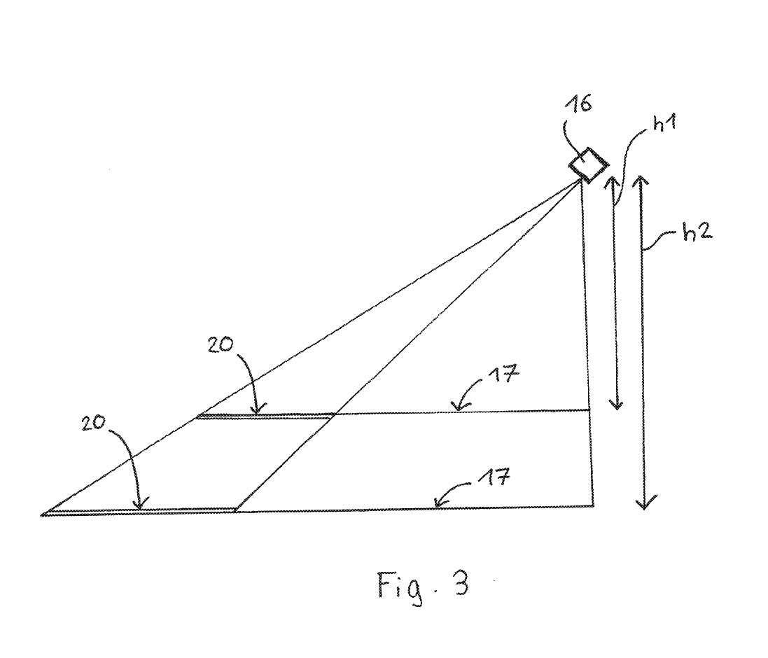

If therefore image-based path length measurements are carried out at different installation heights, the respective measured distance between two points disposed on the road plane 17 depends linearly on the height difference. This can be seen directly from the theorem of intersecting lines. This relationship is illustrated in FIG. 3.

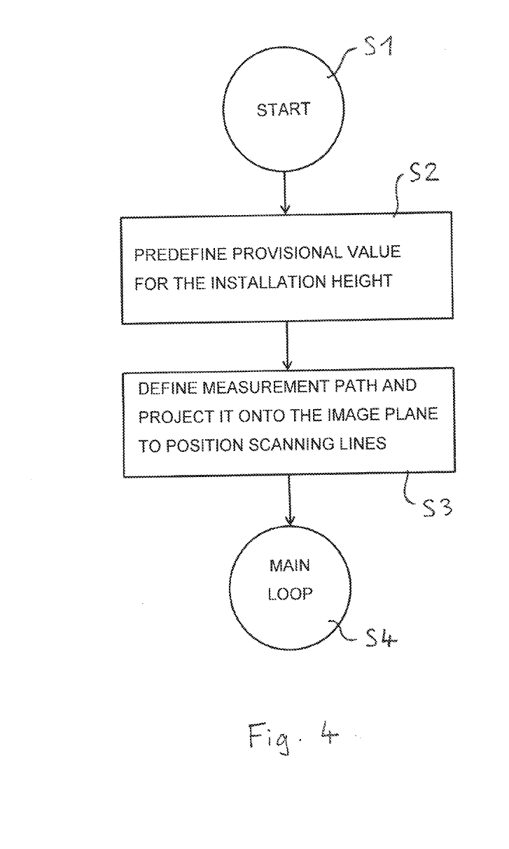

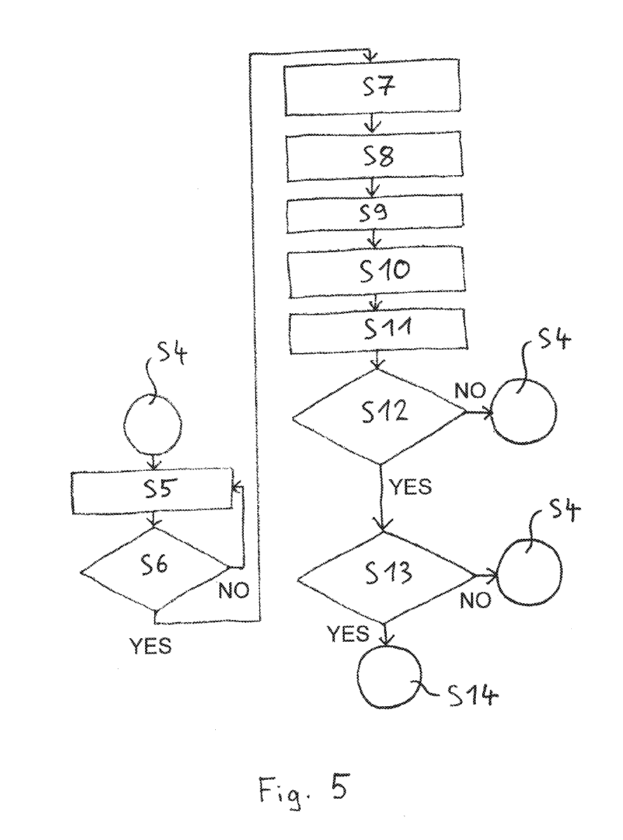

The above-given relationships are used in accordance with the invention for the calibration of the camera 16 of a truck 11, 11′ (FIG. 1) at an unknown installation height. The steps of a corresponding calibration method in accordance with the invention are shown in FIGS. 4 and 5. Before the start of the method, the tilt angle of the camera 16, which the optical axis of the camera 16 includes with the horizon line, is determined using acquired images and objects recognized therein, for example by determining the position of the vanishing point, as described in EP 2 704 096 A1. The current speed and the current yaw rate of the truck 11, 11′ as well as optionally the roll angle of the camera 16 are determined by means of suitable, generally known sensors.

As is shown in FIG. 4, the calibration process is started in step S1. A provisional value for the installation height h is then assumed in step S2. This can take place using a priori information in that, for example, a specific base value or average value is selected for every type of truck 11, 11′ for which the respective driver assistance system is provided.

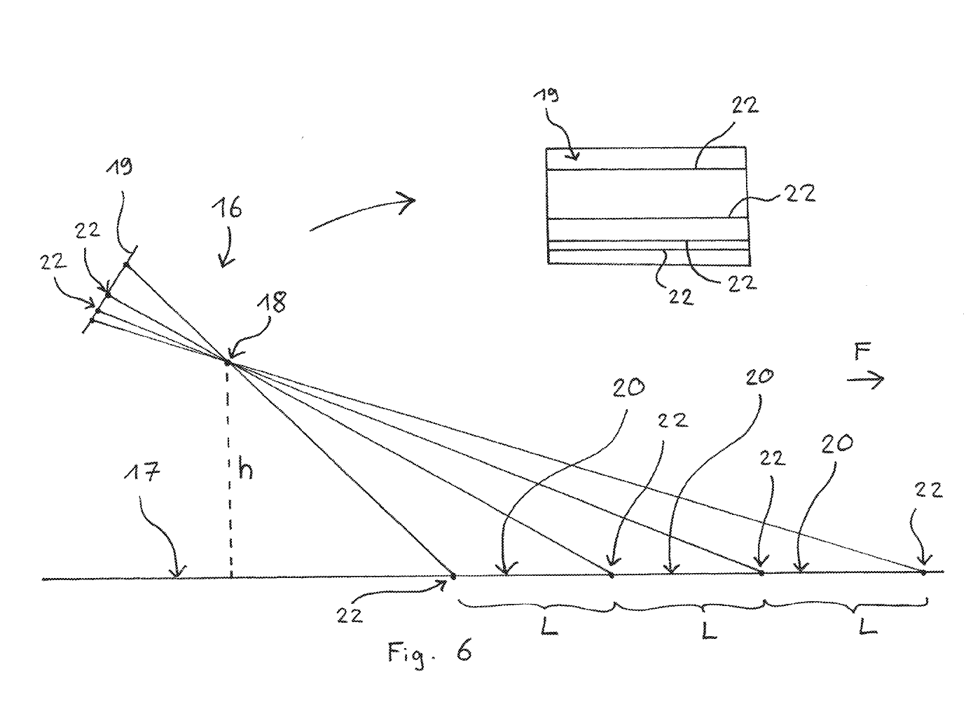

In step S3, a plurality of measurement paths 20 located on the road plane 17 are then defined with a defined path length L, as is illustrated in FIG. 6. A region of the road plane 17 along the direction of travel F observed by the camera can, for example, be divided into ten to twenty sections of equal size from 2 m to 10 m. Scanning lines 22 which extend at right angles to the direction of travel F are fixed in world coordinates for this division. The fixed scanning lines 22 are projected onto the image plane 19 of the camera 16 by means of the inverse perspective mapping algorithm, as is shown in the upper right hand region of FIG. 6. Measurement positions are fixed by the scanning lines 22 which correspond to a respective path start and to a path end of a measurement path 20. It is understood that the value for the installation height h of the camera 16 must be known to apply the projection algorithm. Since the actual installation height is still unknown, the assumed provisional value of the installation height is used as the basis for the perspective projection in step S3.

In step S4, the main loop of the method then starts whose steps are shown in FIG. 5. In step 5, a current image is acquired and the current speed of the truck 11, 11′ is determined. In step 6, a check is made whether the current speed exceeds a threshold value. If this is not the case, the method returns to step S5. If the current speed of the truck 11, 11′ exceeds the threshold value, an object is identified in step S7. This step comprises the application of an object recognition criterion to all of the picture elements associated with the respective scanning line 22. A check can, for example, be made whether a brightness jump which is to be associated with the marking edge of a lane marking occurs at an arbitrary position of a scanning line 22 on an observation of a plurality of images acquired after one another. The output signal of a separate object recognition system, in particular of a classifier, associated with the camera 16 can be used as required. Temporal brightness signals are formed in this manner. These temporal brightness signals are subsequently transformed into spatial brightness signals, that is a one-dimensional coordinate transformation t [symbol] x is carried out. The speed of the truck 11, 11′ is integrated over time for this purpose. The integration can take place numerically using the trapezoidal rule:

Δx=∫ₐ^{b}v(t)dt≈0.5[v(a)+v(b)]

Here, v designates the speed and Δx the spatial distance between two update times a and b. If interrupted lane makings are used as objects to be recognized, the temporal brightness signals and equally the spatial brightness signals are present as rectangular signals.

An autocorrelation is then carried out in steps S8 and S9 to compare the spatial brightness signals of two respectively different scanning lines 22 with one another and in this manner to determine the path covered by an object which is located at the scanning lines 22 at different times t. For this purpose, in step S8, the matrix of the autocorrelation functions is updated and in step 9 a maximum point search is carried out. That path which is covered by an object, that is e.g. a marking edge, which passes the measurement positions in the image one after the other, can be calculated in world coordinates even with noisy brightness signals using the found maximum points.

The path lengths calculated in this way for all the measurement paths 20 are filtered and updated in step S10. Subsequently, in step S11, the calculation of the installation height is carried out, optionally with further filtering. The provisional value of the installation height is in this respect matched using a comparison of the defined path lengths with the respective calculated path lengths to determine the actual value for the installation height. The actual value for the installation height is specifically determined while taking account of the theorem of intersecting lines by a multiplication of the provisional value for the installation height by the ratio from a defined path length and the associated calculated path length of the measurement path 20.

Subsequently, a check is made in step S12 whether an estimated error of the actual value for the installation height falls below a predefined error threshold value. If this is not the case, the method jumps back to the main loop S4. If the estimated value of the actual value for the installation height falls below the predefined error threshold value, however, the camera 16 is calibrated using the actual value for the installation height and the method ends at step S14.

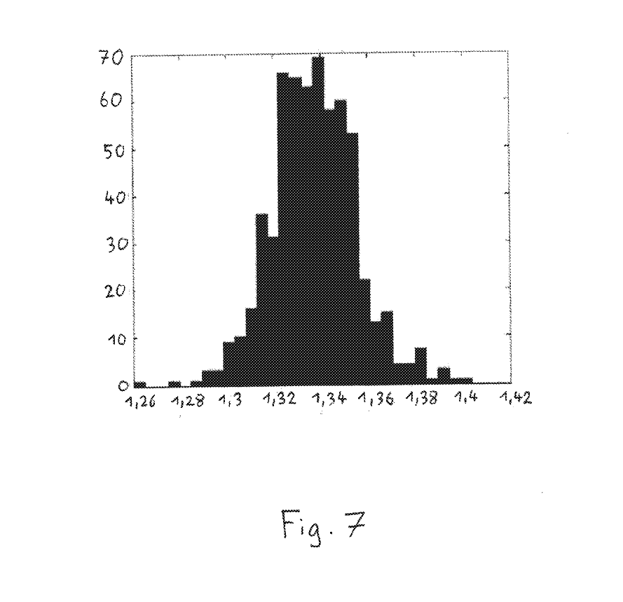

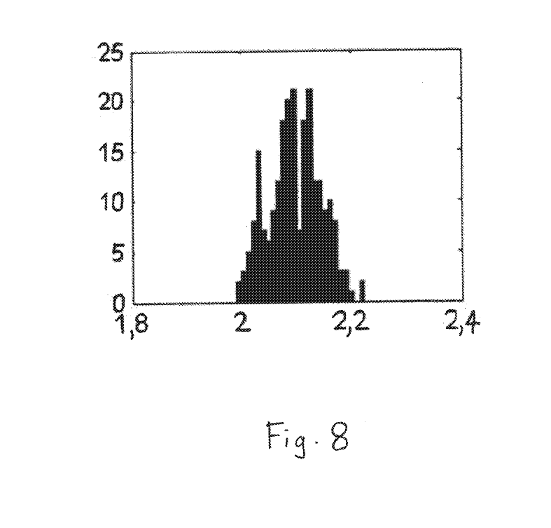

In FIGS. 7 and 8, the results of two tests of the calibration method in accordance with the invention carried out under different conditions are shown. The test runs were each carried out on a computer using recorded image sequences. The results shown in FIG. 7 relate to a camera 16 which is attached to a passenger vehicle. 1000 test runs were carried out using different provisional values for the installation height. The actual installation height of the camera 16 was 1.33 m. The predefined provisional value for the installation height was defined in a random manner in a range of ±0.3 m around the actual value. The mean value of the 1000 test runs was 1.337 m with a standard deviation of 0.017 m.

The results shown in FIG. 8 relate to a camera 16 which is attached to a truck 11, 11′. In this test, the actual installation height was 2.10 m. The range of randomly generated deviations was again ±0.3 m. The mean value of the 300 test runs was 2.098 m with a standard deviation of 0.048 m.

The test results show that a reliable estimate of the actual installation height of a camera 16 arranged at a motor vehicle is possible by means of the method in accordance with the invention, starting from a “reasonable” provisional value for the installation height. A camera 16 can thus be calibrated online even though the actual installation height is not known. The method is in particular suitable for camera calibrations in driver assistance systems for trucks 11, 11′ since relatively pronounced type-dependent fluctuations of the actual installation height is to be anticipated with them. The method is, however, generally also suitable for driver assistance systems which are used with passenger vehicles or motorcycles.

While this invention has been described in terms of the preferred embodiments thereof, it is not intended to be so limited, but rather only to the extent set forth in the claims that follow.

We claim:

1. A method of calibrating an image acquiring device which is arranged on a motor vehicle at an installation height above a road plane and which is able to acquire images of an environment of the motor vehicle at time intervals, wherein
(i) a provisional value is assumed for the installation height;
(ii) at least one measurement path disposed in the road plane is defined with a defined path length;
(iii) the measurement path is projected onto an image plane of the image acquiring device by means of a perspective projection using the provisional value for the installation height in order to determine two measurement positions in the image which correspond to a path start and to a path end of the measurement path;
(iv) at least one object which is located at the two measurement positions at two different times is identified in consecutively acquired images by means of an image processing system;
(iv) a calculated path length of the measurement path is determined from the time difference between the different times and the current speed of the motor vehicle;
(vi) an actual value for the installation height is determined from the provisional value using a comparison of the defined path length with the calculated path length; and
(vii) the image acquiring device is calibrated using the actual value for the installation height.

2. The method in accordance with claim 1, wherein the actual value for the installation height is determined in step (vi) by a multiplication of the provisional value of the installation height by a ratio from the defined path length and the calculated path length of the measurement path.

3. The method in accordance with claim 1, wherein the perspective projection of the defined measurement path onto the image plane of the image acquiring device is carried out in step (iii) by means of an inverse perspective mapping algorithm.

4. The method in accordance with claim 1, wherein a measurement path is defined in step (ii) which extends at least substantially in parallel with a direction of travel of the motor vehicle.

5. The method in accordance with claim 1, wherein scanning lines are determined as measurement positions in step (iii) and extend, preferably horizontally, through the entire image; and in that the identification of at least one object in step (iv) comprises the respective application of an object recognition algorithm to all the picture elements associated with a scanning line.

6. The method in accordance with claim 1, wherein a check is made in step (iv) for the identification of an object at a measurement position whether a brightness jump occurs at the respective measurement position when observing a plurality of images acquired after one another.

7. The method in accordance with claim 1, wherein the identification of an object at a measurement position is carried out in step (iv) using an output signal of a separate object recognition system, in particular of a classifier, associated with the image acquiring device.

8. The method in accordance with claim 1, wherein a front marking edge and/or a rear marking edge of an interrupted lane marking is identified in step (iv).

9. The method in accordance with claim 1, wherein a temporal brightness signal is formed for each of the determined measurement positions using a series of consecutively acquired images and is transformed by a coordinate transformation while integrating the speed of the motor vehicle into a spatial brightness signal.

10. The method in accordance with claim 9, wherein the spatial brightness signals of the two measurement positions are compared with one another by means of autocorrelation to determine the spatial distance between corresponding points of the two spatial brightness signals as a computed path length of the measurement path.

11. The method in accordance with claim 1, wherein a plurality of measurement paths numbering more than five measurement paths are defined in step (ii), wherein respective calculated path lengths are defined for all measurement paths in step (v), wherein the corresponding results are in particular filtered before the calibration.

12. The method in accordance with claim 1, wherein the provisional value for the installation height is predefined using a priori information and in particular in dependence on a type of the motor vehicle.

13. The method in accordance with claim 1, wherein the calibration of the image acquiring device claim 1, wherein is only carried out in step (vii) when the current speed of the motor vehicle claim 1, wherein exceeds a threshold value and the current yaw rate of the motor vehicle falls below a threshold value and an estimated error of the actual value for the installation height falls below a predefined error threshold value.

14. An apparatus for recognizing and tracking an object from a motor vehicle having an image acquiring device which is arranged at the vehicle at a predefined installation height above the road plane and which is configured for taking images of the vehicle environment at time intervals, and having an image processing system which is configured for carrying out a method in accordance with claim 1.

15. A computer program product which contains program instructions which execute a method in accordance with claim 1 when the computer program is run on a computer.
